(19) United States
(12) Patent Application Publication
(10) Pub. No.: US 2025/0363658 A1
(43) Pub. Date: Nov. 27, 2025

(54) LEARNING METHOD AND LEARNING APPARATUS FOR TRAINING DEEP LEARNING-BASED GAZE DETECTION MODEL FOR DETECTING GAZE, AND TEST METHOD AND TEST APPARATUS USING SAME

(71) Applicant: DEEPING SOURCE INC., Seoul (KR)

(72) Inventors: Su Min LEE, Rochester, NY (US); Vladimir Vladimirovich EGAY, Seoul (KR); Yoon Jung HWANG, Seoul (KR)

(21) Appl. No.: 18/872,471

(22) PCT Filed: Aug. 1, 2023
(86) PCT No.: PCT/KR2023/011184

§ 371 Date: Dec. 6, 2024

(30) Foreign Application Priority Data
Aug. 3, 2022 (KR) 10-2022-0096860
Jul. 26, 2023 (KR) 10-2023-0097379

(51) Int. Cl. G06T 7/73; G06V 10/764; G06V 10/766; G06V 10/774; G06V 40/10

(52) U.S. Cl. CPC G06T 7/73; G06V 10/764; G06V 10/766; G06V 10/774; G06V 40/10; G06T 2207/20081; G06T 2207/30196

(57) ABSTRACT

Method for training a deep learning-based gaze detection model includes steps of: (a) generating body direction loss by using predicted body direction information and labeled body direction information included in first ground truth corresponding to the first training image, to thereby train a body FC layer and a body convolutional layer; and (b) inputting a first integrated feature map into a head FC layer, to thereby instruct the head FC layer to perform an FC operation on the first integrated feature map and thus output first predicted head direction information which is acquired by predicting a direction in which a front of a head of a second person is directed, and generating head direction loss by using the first predicted head direction information and labeled head direction information included in second ground truth corresponding to the second training image, to thereby train the head FC layer and a head convolutional layer.

### FIELD OF THE DISCLOSURE

The present disclosure relates to a method for training a gaze detection model that detects a gaze based on deep learning; and more particularly, a learning method and a learning device for training the deep learning-based gaze detection model that detects the gaze of a person by using body direction information and head direction information of the person, and a test method and a test device using the same.

### BACKGROUND OF THE DISCLOSURE

Gaze information, i.e., gaze direction information, can be used in various fields, for example, the gaze information can be used in the marketing field to analyze whether an advertisement is effective.

Conventionally, it has remained at the level of photographing a user's facial image through a camera mounted on a user terminal, and obtaining the user's gaze information from the user's facial image.

However, the conventional method as above for detecting the gaze information has a problem in that it can only be used in situations with extremely limited conditions, such as, for example, a situation of a user watching a specific content through a camera-equipped mobile phone.

Another conventional method for detecting the gaze information is to detect a pupil from a facial image where a person's face is detected, detect a light reflection point within the pupil, and thus detect the gaze information by referring to the detected light reflection point. Therefore, the another conventional method is also difficult to be applied when the pupil is not captured in the image.

Therefore, an improved method is required to solve the above problems.

### DETAILED EXPLANATION OF THE INVENTION

### Objects of the Invention

It is an object of the present disclosure to solve all the aforementioned problems.

It is another object of the present disclosure to accurately detect a gaze.

It is still another object of the present disclosure to accurately detect the gaze by using head direction information and body direction information.

It is still yet another object of the present disclosure to support effective advertising to consumers by accurately detecting the gaze.

### Means of Solving the Problem

In order to accomplish objects above, representative structures of the present disclosure are described as follows: In accordance to one aspect of the present disclosure, there is provided a method of training a gaze detection model that detects a gaze of a person based on deep learning, comprising steps of: (a) in response to acquiring at least one first training image, a learning device (i) inputting the first training image into a body convolutional layer, to thereby instruct the body convolutional layer to perform a convolutional operation on the first training image at least once and thus generate at least one first body feature map which is acquired by extracting body features of a first person included in the first training image, (ii) inputting the first body feature map into a body fully connected (FC) layer, to thereby instruct the body FC layer to perform an FC operation on the first body feature map at least once and thus output at least one predicted body direction information which is acquired by predicting a direction in which a front of a body of the first person faces, and (iii) generating at least one body direction loss by referring to the predicted body direction information and a labeled body direction information included in a first ground truth corresponding to the first training image, to thereby train the body FC layer and the body convolutional layer; and (b) in response to acquiring at least one second training image, the learning device (i) inputting the second training image into the body convolutional layer, to thereby instruct the body convolutional layer to perform the convolutional operation on the second training image at least once and thus generate at least one second body feature map which is acquired by extracting body features of a second person included in the second training image, inputting the second training image into a head convolutional layer, to thereby instruct the head convolutional layer to perform the convolutional operation on the second training image at least once and thus generate at least one first head feature map which is acquired by extracting head features of the second person, and concatenating the second body feature map and the first head feature map to generate a first integrated feature map, (ii) inputting the first integrated feature map into a head FC layer, to thereby instruct the head FC layer to perform an FC operation on the first integrated feature map at least once and thus output at least one first predicted head direction information which is acquired by predicting a direction in which a front of a head of the second person is directed, and (iii) generating at least one head direction loss by referring to the first predicted head direction information and a labeled head direction information included in a second ground truth corresponding to the second training image, to thereby train the head FC layer and the head convolutional layer.

As one example, at the step of (b), the learning device further adds a loss weight to the head direction loss to thereby train the head FC layer and the head convolutional layer, wherein, in case the head direction loss is less than a preset threshold, “0” is applied as the loss weight, and wherein, in case the head direction loss is equal to or greater than the preset threshold, a preset real number greater than “0” is applied as the loss weight.

As one example, at the step of (b), the learning device instructs the head FC layer to output, as the first predicted head direction information, either (i) classification information which is acquired by classifying which class among preset head direction classes corresponds to the direction in which the front of the head of the second person is directed, or (ii) regression information which is acquired by regressing which direction among continuous direction candidates corresponds to the direction in which the front of the head of the second person is directed.

As one example, the first predicted head direction information is a prediction of the direction in which the front of the head of the second person is directed in either a two-dimensional plane corresponding to the second training image or a three-dimensional space corresponding to the second training image.

As one example, the first training image or the second training image is generated, in a photographed or cropped image of a person, (i) by labeling each of a body direction and a gaze of the corresponding person with each of a specific body direction class and a specific gaze class, each of which corresponds to each one among preset body direction classes and preset gaze classes in a two-dimensional plane or a three-dimensional space, or (ii) by labeling each of the body direction and the gaze of the corresponding person with each of a body direction vector and a gaze vector in the two-dimensional plane or the three-dimensional space.

As one example, the first training image or the second training image is generated, in a photographed image of a person wearing a gyroscope sensor, (i) by labeling with each of a specific body direction class and a specific gaze class, each of which corresponds to each of sensed body direction information and sensed gaze information among preset body direction classes and preset gaze classes in a two-dimensional plane or a three-dimensional space, or (ii) by labeling each of the sensed body direction information and the sensed gaze information in the two-dimensional plane or the three-dimensional space with each of a body direction vector and a gaze vector of corresponding person, through using the sensed body direction information and the sensed gaze information of the corresponding person which is acquired by using sensing information of the gyroscope sensor at a time of shooting.

As one example, further comprises a step of: (c) the learning device (i) inputting at least one evaluation image into the body convolutional layer, to thereby instruct the body convolutional layer to perform the convolutional operation on the evaluation image at least once and thus generate at least one third body feature map which is acquired by extracting body features of a third person included in the evaluation image, inputting the evaluation image into the head convolutional layer, to thereby instruct the head convolutional layer to perform the convolutional operation on the evaluation image at least once and thus generate at least one second head feature map which is acquired by extracting head features of the third person included in the evaluation image, and concatenating the third body feature map and the second head feature map to generate a second integrated feature map, (ii) inputting the second integrated feature map into the head FC layer, to thereby instruct the head FC layer to perform the FC operation on the second integrated feature map at least once and thus output at least one second predicted head direction information which is acquired by predicting a direction in which a front of a head of the third person is directed, and (iii) evaluating the gaze detection model including the body convolutional layer, the head convolutional layer, and the head FC layer by referring to the second predicted head direction information and a third ground truth corresponding to the evaluation image.

As one example, the learning device calculates a degree of accuracy using the second predicted head direction information and the third ground truth with a following mathematical formula, to thereby evaluate the gaze detection model using the calculated the degree of accuracy.

$$\frac{( \# of predicted soft corrects \times \frac{1}{2} + \# of predicted corrects )}{N}$$

In the above mathematical formula, the N is a total number of the second predicted head direction information used for evaluation, the # of predicted soft corrects is a cardinal number of a part of the second predicted head direction information that did not accurately predict a labeled correct answer, and the # of predicted corrects is a cardinal number of a part of the second predicted head direction information that accurately predicted the labeled correct answer.

In accordance with another aspect of the present disclosure, there is provided a method of training a gaze detection model that detects a gaze of a person based on deep learning, comprising steps of: (a) in response to acquiring at least one training image, a learning device (i) inputting the training image into a body convolutional layer, to thereby instruct the body convolutional layer to perform a convolutional operation on the training image at least once and thus generate at least one body feature map which is acquired by extracting body features of a person included in the training image, (ii) inputting the training image into a head convolutional layer, to thereby instruct the head convolutional layer to perform a convolutional operation on the training image at least once and thus generate at least one head feature map which is acquired by extracting head features of a person included in the training image; (b) the learning device (i) inputting the body feature map into a body FC layer, to thereby instruct the body FC layer to perform an FC operation on the body feature map at least once and thus output at least one predicted body direction information which is acquired by predicting a direction in which a front of a body of the person faces, and (ii) inputting an integrated feature map, which is generated by concatenating the body feature map and the head feature map, into a head FC layer, to thereby instruct the head FC layer to perform an FC operation on the integrated feature map at least once and thus output at least one predicted head direction information which is acquired by predicting a direction in which a front of a head of the person is directed; and (c) the learning device (i) generating at least one body direction loss by referring to the predicted body direction information and a labeled body direction information included in a ground truth corresponding to the training image, and generating at least one head direction loss by referring to the predicted head direction information and a labeled head direction information included in the ground truth, and (ii) training the body FC layer and the body convolutional layer by referring to the body direction loss and training the head FC layer and the head convolutional layer by referring to the head direction loss.

As one example, the training image is generated, in a photographed or cropped image of a person, (i) by labeling each of a body direction and a gaze of the corresponding person with each of a specific body direction class and a specific gaze class, each of which corresponds to each one among preset body direction classes and preset gaze classes in a two-dimensional plane or a three-dimensional space, or (ii) by labeling each of the body direction and the gaze of the corresponding person with each of a body direction vector and a gaze vector in the two-dimensional plane or the three-dimensional space.

As one example, the training image is generated, in a photographed image of a person wearing a gyroscope sensor, (i) by labeling with each of a specific body direction class and a specific gaze class, each of which corresponds to each of sensed body direction information and sensed gaze information among preset body direction classes and preset gaze classes in a two-dimensional plane or a three-dimensional space, or (ii) by labeling each of the sensed body direction information and the sensed gaze information in the two-dimensional plane or the three-dimensional space with each of a body direction vector and a gaze vector of corresponding person, through using the sensed body direction information and the sensed gaze information of the corresponding person which is acquired by using sensing information of the gyroscope sensor at a time of shooting.

In accordance with still another aspect of the present disclosure, there is provided a learning device for training a gaze detection model that detects a gaze of a person based on deep learning, comprising: at least one memory that stores instructions for training a gaze detection model that detects a gaze of a person based on deep learning; and at least one processor configured to perform an operation for training the gaze detection model by executing the instructions stored in the memory, wherein the processor performs processes of: (I) in response to acquiring at least one first training image, (i) inputting the first training image into a body convolutional layer, to thereby instruct the body convolutional layer to perform a convolutional operation on the first training image at least once and thus generate at least one first body feature map which is acquired by extracting body features of a first person included in the first training image, (ii) inputting the first body feature map into a body fully connected (FC) layer, to thereby instruct the body FC layer to perform an FC operation on the first body feature map at least once and thus output at least one predicted body direction information which is acquired by predicting a direction in which a front of a body of the first person faces, and (iii) generating at least one body direction loss by referring to the predicted body direction information and a labeled body direction information included in a first ground truth corresponding to the first training image, to thereby train the body FC layer and the body convolutional layer; and (II) in response to acquiring at least one second training image, (i) inputting the second training image into the body convolutional layer, to thereby instruct the body convolutional layer to perform the convolutional operation on the second training image at least once and thus generate at least one second body feature map which is acquired by extracting body features of a second person included in the second training image, inputting the second training image into a head convolutional layer, to thereby instruct the head convolutional layer to perform the convolutional operation on the second training image at least once and thus generate at least one first head feature map which is acquired by extracting head features of the second person, and concatenating the second body feature map and the first head feature map to generate a first integrated feature map, (ii) inputting the first integrated feature map into a head FC layer, to thereby instruct the head FC layer to perform an FC operation on the first integrated feature map at least once and thus output at least one first predicted head direction information which is acquired by predicting a direction in which a front of a head of the second person is directed, and (iii) generating at least one head direction loss by referring to the first predicted head direction information and a labeled head direction information included in a second ground truth corresponding to the second training image, to thereby train the head FC layer and the head convolutional layer.

As one example, at the process of (II), the processor further adds a loss weight to the head direction loss to thereby train the head FC layer and the head convolutional layer, wherein, in case the head direction loss is less than a preset threshold, “O” is applied as the loss weight, and wherein, in case the head direction loss is equal to or greater than the preset threshold, a preset real number greater than “0” is applied as the loss weight.

As one example, at the process of (II), the processor instructs the head FC layer to output, as the first predicted head direction information, either (i) classification information which is acquired by classifying which class among preset head direction classes corresponds to the direction in which the front of the head of the second person is directed, or (ii) regression information which is acquired by regressing which direction among continuous direction candidates corresponds to the direction in which the front of the head of the second person is directed.

As one example, the first predicted head direction information is a prediction of the direction in which the front of the head of the second person is directed in either a two-dimensional plane corresponding to the second training image or a three-dimensional space corresponding to the second training image.

As one example, the first training image or the second training image is generated, in a photographed or cropped image of a person, (i) by labeling each of a body direction and a gaze of the corresponding person with each of a specific body direction class and a specific gaze class, each of which corresponds to each one among preset body direction classes and preset gaze classes in a two-dimensional plane or a three-dimensional space, or (ii) by labeling each of the body direction and the gaze of the corresponding person with each of a body direction vector and a gaze vector in the two-dimensional plane or the three-dimensional space.

As one example, the first training image or the second training image is generated, in a photographed image of a person wearing a gyroscope sensor, (i) by labeling with each of a specific body direction class and a specific gaze class, each of which corresponds to each of sensed body direction information and sensed gaze information among preset body direction classes and preset gaze classes in a two-dimensional plane or a three-dimensional space, or (ii) by labeling each of the sensed body direction information and the sensed gaze information in the two-dimensional plane or the three-dimensional space with each of a body direction vector and a gaze vector of corresponding person, through using the sensed body direction information and the sensed gaze information of the corresponding person which is acquired by using sensing information of the gyroscope sensor at a time of shooting.

As one example, the processor further performs a process of: (III) (i) inputting at least one evaluation image into the body convolutional layer, to thereby instruct the body convolutional layer to perform the convolutional operation on the evaluation image at least once and thus generate at least one third body feature map which is acquired by extracting body features of a third person included in the evaluation image, inputting the evaluation image into the head convolutional layer, to thereby instruct the head convolutional layer to perform the convolutional operation on the evaluation image at least once and thus generate at least one second head feature map which is acquired by extracting head features of the third person included in the evaluation image, and concatenating the third body feature map and the second head feature map to generate a second integrated feature map, (ii) inputting the second integrated feature map into the head FC layer, to thereby instruct the head FC layer to perform the FC operation on the second integrated feature map at least once and thus output at least one second predicted head direction information which is acquired by predicting a direction in which a front of a head of the third person is directed, and (iii) evaluating the gaze detection model including the body convolutional layer, the head convolutional layer, and the head FC layer by referring to the second predicted head direction information and a third ground truth corresponding to the evaluation image.

As one example, the processor calculates a degree of accuracy using the second predicted head direction information and the third ground truth with a following mathematical formula, to thereby evaluate the gaze detection model using the calculated the degree of accuracy.

$$\frac{( \# of predicted soft corrects \times \frac{1}{2} + \# of predicted corrects )}{N}$$

In the above mathematical formula, the N is a total number of the second predicted head direction information used for evaluation, the # of predicted soft corrects is a cardinal number of a part of the second predicted head direction information that did not accurately predict a labeled correct answer, and the # of predicted corrects is a cardinal number of a part of the second predicted head direction information that accurately predicted the labeled correct answer.

In accordance with still yet another aspect of the present disclosure, there is provided a learning device for training a gaze detection model that detects a gaze of a person based on deep learning, comprising: at least one memory that stores instructions for training a gaze detection model that detects a gaze of a person based on deep learning; and at least one processor configured to perform an operation for training the gaze detection model by executing the instructions stored in the memory, wherein the processor performs processes of: (I) in response to acquiring at least one training image, (i) inputting the training image into a body convolutional layer, to thereby instruct the body convolutional layer to perform a convolutional operation on the training image at least once and thus generate at least one body feature map which is acquired by extracting body features of a person included in the training image, (ii) inputting the training image into a head convolutional layer, to thereby instruct the head convolutional layer to perform a convolutional operation on the training image at least once and thus generate at least one head feature map which is acquired by extracting head features of a person included in the training image; (II) (i) inputting the body feature map into a body FC layer, to thereby instruct the body FC layer to perform a n FC operation on the body feature map at least once and thus output at least one predicted body direction information which is acquired by predicting a direction in which a front of a body of the person faces, and (ii) inputting an integrated feature map, which is generated by concatenating the body feature map and the head feature map, into a head FC layer, to thereby instruct the head FC layer to perform an FC operation on the integrated feature map at least once and thus output at least one predicted head direction information which is acquired by predicting a direction in which a front of a head of the person is directed; and (III) (i) generating at least one body direction loss by referring to the predicted body direction information and a labeled body direction information included in a ground truth corresponding to the training image, and generating at least one head direction loss by referring to the predicted head direction information and a labeled head direction information included in the ground truth, and (ii) training the body FC layer and the body convolutional layer by referring to the body direction loss and training the head FC layer and the head convolutional layer by referring to the head direction loss.

As one example, the training image is generated, in a photographed or cropped image of a person, (i) by labeling each of a body direction and a gaze of the corresponding person with each of a specific body direction class and a specific gaze class, each of which corresponds to each one among preset body direction classes and preset gaze classes in a two-dimensional plane or a three-dimensional space, or (ii) by labeling each of the body direction and the gaze of the corresponding person with each of a body direction vector and a gaze vector in the two-dimensional plane or the three-dimensional space.

As one example, the training image is generated, in a photographed image of a person wearing a gyroscope sensor, (i) by labeling with each of a specific body direction class and a specific gaze class, each of which corresponds to each of sensed body direction information and sensed gaze information among preset body direction classes and preset gaze classes in a two-dimensional plane or a three-dimensional space, or (ii) by labeling each of the sensed body direction information and the sensed gaze information in the two-dimensional plane or the three-dimensional space with each of a body direction vector and a gaze vector of corresponding person, through using the sensed body direction information and the sensed gaze information of the corresponding person which is acquired by using sensing information of the gyroscope sensor at a time of shooting.

### Effects of the Invention

The present disclosure has an effect of accurately detecting the gaze.

Moreover, the present disclosure has another effect of accurately detecting the gaze using the head direction information and the body direction information.

Moreover, the present disclosure has another effect of supporting effective advertising to consumers by accurately detecting the gaze.

### BRIEF DESCRIPTION OF THE DRAWINGS

The following drawings to be used for explaining example embodiments of the present disclosure are only part of example embodiments of the present disclosure and other drawings can be acquired based on the drawings by those skilled in the art of the present disclosure without inventive work.

FIG. 1 is a drawing schematically illustrating a learning device for training a gaze detection model that detects a gaze based on deep learning in accordance with one example embodiment of the present disclosure.

FIG. 2 is a drawing schematically illustrating a learning method for training the gaze detection model that detects the gaze based on deep learning in accordance with one example embodiment of the present disclosure.

FIG. 3 is a drawing schematically illustrating the learning method for training the gaze detection model that detects the gaze based on deep learning in accordance with one example embodiment of the present disclosure.

FIG. 4 is a drawing schematically illustrating a test device for testing the gaze detection model that detects the gaze based on deep learning in accordance with one example embodiment of the present disclosure.

FIG. 5 is a drawing schematically illustrating a test method for testing the gaze detection model that detects the gaze based on deep learning in accordance with one example embodiment of the present disclosure.

FIG. 6 is a drawing schematically illustrating a training image used for training the gaze detection model that detects the gaze based on deep learning in accordance with one example embodiment of the present disclosure.

### DETAILED DESCRIPTION OF THE PREFERRED EMBODIMENTS

The following detailed description of the present disclosure refers to the accompanying drawings, which show by way of illustration, a specific embodiment in which the present disclosure may be practiced, in order to clarify the objects, technical solutions and advantages of the present disclosure. These embodiments are described in sufficient detail to enable those skilled in the art to practice the present disclosure.

Besides, in the detailed description and claims of the present disclosure, a term “include” and its variations are not intended to exclude other technical features, additions, components, or steps. Other objects, benefits and features of the present disclosure will be revealed to one skilled in the art, partially from the specification and partially from the implementation of the present disclosure. The following examples and drawings will be provided as examples, but they are not intended to limit the present disclosure.

Moreover, the present disclosure covers all possible combinations of example embodiments indicated in this specification. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

The headings and abstract of the present disclosure provided herein are for convenience only and do not limit or interpret the scope or meaning of the embodiments.

In the following description, a case of detecting a gaze of a pedestrian is described as an example, but the present disclosure is not limited thereto, and the present disclosure can be applied even to non-pedestrians.

To allow those skilled in the art to the present disclosure to be carried out easily, the example embodiments of the present disclosure by referring to attached diagrams will be explained in detail as shown below.

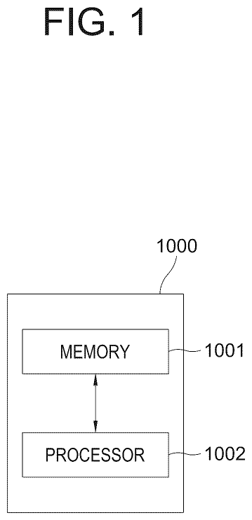

FIG. 1 is a drawing schematically illustrating a learning device 1000 for training a gaze detection model that detects a gaze based on deep learning in accordance with one example embodiment of the present disclosure. The learning device 1000 may include at least one memory 1001 that stores instructions for training the gaze detection model and at least one processor 1002 configured to perform operations for training the gaze detection model by executing the instructions stored in the memory 1001. Herein, the gaze detection model may include a body convolutional layer, a head convolutional layer, and a head fully connected (FC) layer, which will be explained in detail in the following learning method.

Specifically, the learning device 1000 may achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network attached storage (NAS) device and a storage area network (SAN) as the computing device and any instructions that allow the computing device to function in a specific way as the computer software.

The processor of the computing device may include hardware configuration of MPU (Micro Processing Unit) or CPU (Central Processing Unit), cache memory, data bus, etc. Additionally, the computing device may further include OS and software configuration of applications that achieve specific purposes.

Such description of the computing device does not exclude an integrated device including any combination of a processor, a memory, a medium, or any other computing components for implementing the present disclosure.

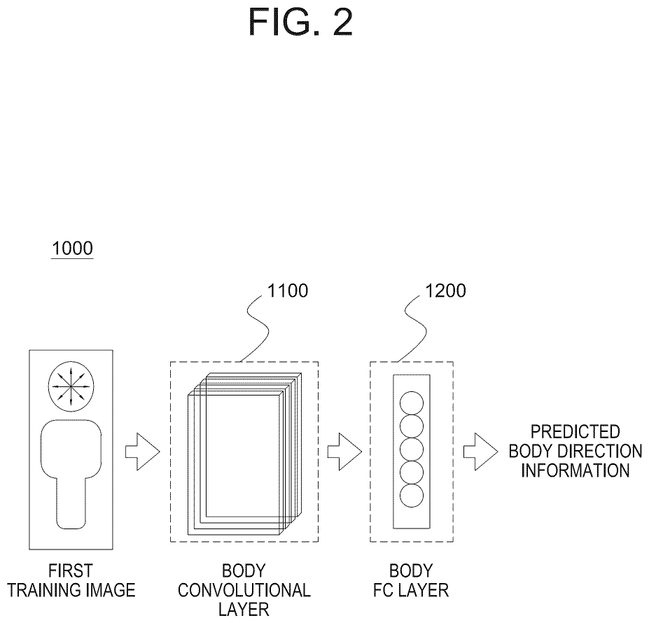

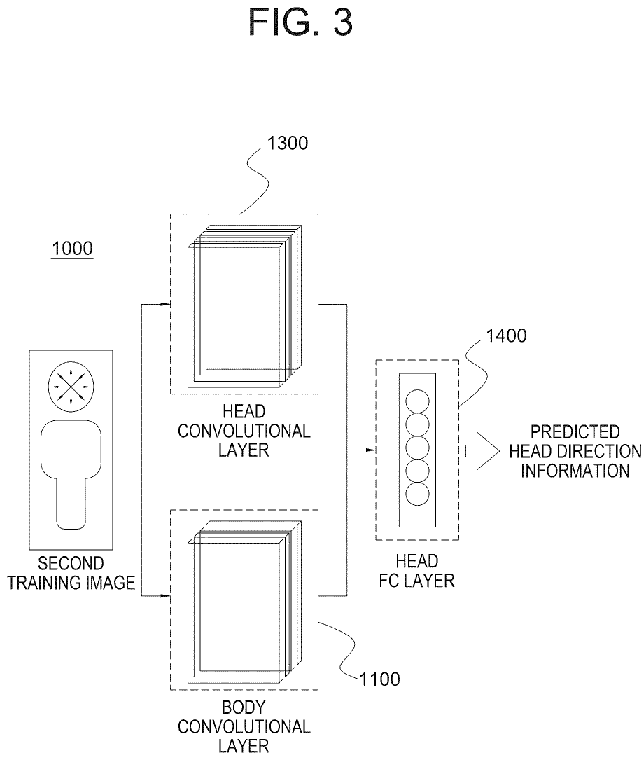

The learning method for training the gaze detection model that detects the gaze by using the learning device 1000 with the above configuration will be described below, with reference to FIG. 2 and FIG. 3.

For reference, even if each component is described in singular form below, the possibility of plural form is not excluded.

For reference, it is generally easier to predict which direction a body of a pedestrian is moving than to predict which direction a face of the pedestrian is directed. This is because the direction in which the body of the pedestrian is moving can be predicted based on a wealth of information such as information on the pedestrian's arms, legs, hands and feet.

Thus, in order to increase the learning efficiency, the learning device 1000 in accordance with one example embodiment of the present disclosure may firstly train parameters of the body convolutional layer 1100 that extracts features related to the direction in which the body of the pedestrian is moving, and then, on condition that the parameters of the body convolutional layer 1100 is fixed, train parameters of the head convolutional layer 1300, which extracts features related to the direction in which the face of the pedestrian is directed, and parameters of the head FC layer 1400.

However, the present disclosure is not limited thereto, and the learning device 1000 according to the present disclosure may simultaneously train the parameters of the body convolutional layer 1100, the head convolutional layer 1300 and the head FC layer 1400.

For the convenience, a case of firstly training the parameters of the body convolutional layer 1100 that extracts features related to the direction in which the body of the pedestrian is moving, and then, on condition that the parameters of the body convolutional layer 1100 is fixed, training the parameters of the head convolutional layer 1300, which extracts features related to the direction in which the face of the pedestrian is directed, and the parameters of the head FC layer 1400 will be described first, and a case of simultaneously training the parameters of the body convolutional layer 1100, the head convolutional layer 1300 and the head FC layer 1400 will be described later.

Referring to FIG. 2, in response to acquiring at least one first training image, for example, an image of the pedestrian, the learning device 1000 may input the first training image into the body convolutional layer 1100, to thereby instruct the body convolutional layer 1100 to perform at least one convolutional operation on the first training image and thus generate at least one first body feature map. That is, the learning device 1000 may instruct the body convolutional layer 1100 to perform the convolutional operation on the first training image at least once and thus generate the at least one first body feature map by extracting body features of a first person included in the first training image.

For reference, the first training image and a second training image to be described later may be different training images, but are not limited thereto, and may be the same training image.

Also, the first training image, the second training image and a text image to be described later may be acquired by CCTV, but are not limited thereto.

Next, the learning device 1000 may input the first body feature map into the body fully connected (FC) layer 1200, to thereby instruct the body FC layer 1200 to perform at least one FC operation and thus output at least one predicted body direction information. That is, the learning device 1000 may instruct the body FC layer 1200 to perform the FC operation on the first body feature map at least once and thus output at least one predicted body direction information by predicting a direction in which a front of a body of the first person faces.

Herein, the learning device 1000 may instruct the body FC layer 1200 to output one of classification information, i.e., information having discontinuous values, as the predicted body direction information, but is not limited thereto, and may instruct the body FC layer 1200 to output one of regression information, i.e., information having continuous values, as the predicted body direction information.

That is, the learning device 1000 may instruct the body FC layer 1200 to output, as the predicted body direction information, either (i) classification information which is acquired by classifying which body direction class among preset body direction classes corresponds to the direction in which the front of the body of the first person faces, or (ii) regression information which is acquired by regressing which direction candidate among continuous direction candidates corresponds to the direction in which the front of the body of the first person faces.

As an example, when the direction in which the front of the body of the first person (i.e., the pedestrian) faces, with the body of the pedestrian as the center, is facing the camera (e.g., facing south), the predicted body direction information may be the classification information acquired by classifying which body direction class among eight preset body direction classes, i.e., S, SE, E, NE, N, NW, W, SW on a two-dimensional plane, corresponds to the direction in which the front of the body of the pedestrian faces.

For another example, when the direction in which the front of the body of the first person (i.e., the pedestrian) faces, with the body of the pedestrian as the center, is facing the camera (e.g., facing 0 degrees), the predicted body direction information may be the regression information acquired by regressing which direction among all directions of 360 degrees on a two-dimensional plane, for example, a direction of 150.1482 degrees, corresponds to the direction in which the front of the body of the pedestrian faces.

Meanwhile, although the predicted body direction information above is described as the classification information or the regression information on the two-dimensional plane, it may also be classification information or regression information in a three-dimensional space.

That is, when the direction in which the front of the body of the first person (i.e., the pedestrian) faces, with the body of the pedestrian as the center, is facing the camera, the predicted body direction information may be (i) classification information which is acquired by classifying which body direction class among 26 preset body direction classes along radial directions in the three-dimensional space (i.e., classes including eight body direction classes up to an upper direction, eight body direction classes up to a lower direction, an upper direction class, and a lower direction class, in addition to the eight preset body direction classes on a two-dimensional plane) corresponds to the direction in which the front of the body of the pedestrian faces, or (ii) regression information which is acquired by regressing which direction among continuous directions according to a three-dimensional spherical coordinate system corresponds to the direction in which the front of the body of the pedestrian faces.

As a result, the predicted body direction information may be one of (i) the classification information on the two-dimensional plane, (ii) the regression information on the two-dimensional plane, (iii) the classification information in the three-dimensional space, and (iv) the regression information in the three-dimensional space, depending on settings of the body FC layer 1200.

Referring to FIG. 2 again, the learning device 1000 may generate at least one body direction loss by referring to at least one predicted body direction information and a labeled body direction information included in a first ground truth corresponding to the first training image, to thereby train at least some parameters of the body convolutional layer 1100 and the body FC layer 1200 through backpropagation using the body direction loss. That is, the learning device 1000 may train the body convolutional layer 1100 and the body FC layer 1200 using the body direction loss.

After training the parameters of the body convolutional layer 1100 and the body FC layer 1200 as described above, the learning device 1000 may train at least some parameters of the head convolutional layer 1300 and the head FC layer 1400 while the parameters of the body convolutional layer 1100 are fixed.

For reference, as explained above, there are many cases where eyes, i.e., the pupils, of the pedestrian are not captured. However, the direction in which the face of the pedestrian is directed is considered to be the direction in which the gaze of the pedestrian is directed, in accordance with one example embodiment of the present disclosure, and eventually, the gaze of the pedestrian can be accurately predicted regardless of various environments of capturing images.

Referring to FIG. 3, in response to acquiring at least one second training image, for example, an image of the pedestrian, the learning device 1000 may input the second training image into the head convolutional layer 1300 and the body convolutional layer 1100, to thereby instruct each of the head convolutional layer 1300 and the body convolutional layer 1100 to perform the convolutional operation on the second training image respectively and thus generate at least one first head feature map and at least one second body feature map respectively.

That is, the learning device 1000 may input the second training image into the body convolutional layer 1100, to thereby instruct the body convolutional layer 1100 to perform the convolutional operation on the second training image at least once and thus generate at least one second body feature map which is acquired by extracting body features of a second person included in the second training image, and input the second training image into the head convolutional layer 1300, to thereby instruct the head convolutional layer 1300 to perform the convolutional operation on the second training image at least once and thus generate at least one first head feature map which is acquired by extracting head features of the second person.

For reference, the body FC layer 1200 explained with reference to FIG. 2 may be used only in the process of training the parameters of the body convolutional layer 1100, and may not be used in the process of training the head convolutional layer 1300 and the head FC layer 1400, as shown in FIG. 3. That is, the gaze detection model according to the present disclosure may include the body convolutional layer 1100, the head convolutional layer 1300, and the head FC layer 1400. Herein the body FC layer 1200 may be used only in the process of training the gaze detection model.

Next, the learning device 1000 may concatenate the second head feature map and the first body feature map to generate a first integrated feature map, and input the first integrated feature map into the head fully connected (FC) layer 1400, to thereby instruct the head FC layer 1400 to perform an FC operation on the first integrated feature map at least once and thus output at least one first predicted head direction information which is acquired by predicting a direction in which a front of a head of the second person is directed.

Herein, the learning device 1000 may instruct the head FC layer 1400 to output one of classification information, i.e., information having discontinuous values, as the first predicted head direction information, but is not limited thereto, and may instruct the head FC layer 1400 to output one of regression information, i.e., information having continuous values, as the first predicted head direction information.

That is, the learning device 1000 may instruct the head FC layer 1400 to output, as the first predicted head direction information, either (i) classification information which is acquired by classifying which head direction class among preset head direction classes corresponds to the direction in which the front of the head of the second person is directed, or (ii) regression information which is acquired by regressing which direction candidate among continuous direction candidates corresponds to the direction in which the front of the head of the second person is directed.

As one example, when the direction in which the front of the head of the second person (i.e., the pedestrian) is directed, with the head of the pedestrian as the center, is facing the camera (e.g., facing south), the first predicted head direction information may be the classification information acquired by classifying which head direction class among eight preset head direction classes, i.e., S, SE, E, NE, N, NW, W, SW on a two-dimensional plane, corresponds to the direction in which the front of the head of the pedestrian is directed. Herein, the first predicted head direction information may be the classification information which is acquired by classifying among classes including an additional class for a direction in which the front of the head of the pedestrian does not correspond to any of the eight preset head direction classes. Herein, the additional class represents a default direction class corresponding to a case in which the pedestrian is directed to himself or herself.

For another example, when the direction in which the front of the head (i.e., a face) of the second person (i.e., the pedestrian) is directed, with the head of the pedestrian as the center, is facing the camera (e.g., facing 0 degree), the first predicted head direction information may be the regression information acquired by regressing which direction among all directions of 360 degrees on a two-dimensional plane, for example, a direction of 150.1482 degrees, corresponds to the direction in which the front of the head of the pedestrian is directed. Herein, the first predicted head direction information may be the regression information which is acquired by regressing among directions including an additional direction in which the front of the head of the pedestrian does not correspond to any of the directions of 360 degrees. Herein, the additional direction represents a default direction corresponding to a case in which the pedestrian is directed to himself or herself.

Meanwhile, although the first predicted head direction information above is described as the classification information or the regression information on the two-dimensional plane, it may also be classification information or regression information in the three-dimensional space.

That is, when the direction in which the front of the head of the second person (i.e., the pedestrian) is directed, with the head of the pedestrian as the center, is directed to the camera, the first predicted head direction information may be (i) classification information which is acquired by classifying which head direction class among 26 preset head direction classes along radial directions in the three-dimensional space (i.e., classes including eight head direction classes up to an upper direction, eight head direction classes up to a lower direction, an upper direction class, and a lower direction class, in addition to the eight preset head direction classes on a two-dimensional plane) corresponds to the direction in which the front of the head of the pedestrian is directed, or (ii) regression information which is acquired by regressing which direction among continuous directions according to a three-dimensional spherical coordinate system corresponds to the direction in which the front of the head of the pedestrian is directed.

As a result, the first predicted head direction information may be one of (i) the classification information on the two-dimensional plane, (ii) the regression information on the two-dimensional plane, (iii) the classification information in the three-dimensional space, and (iv) the regression information in the three-dimensional space, depending on settings of the head FC layer 1400.

Referring to FIG. 3 again, the learning device 1000 may generate at least one head direction loss by referring to at least one first predicted head direction information and at least one GT head direction information corresponding thereto, to thereby train at least some parameters of the head convolution layer 1300 and the head FC layer 1400 through backpropagation using the head direction loss. That is, the learning device 1000 may generate the at least one head direction loss by referring to the first predicted head direction information and a labeled head direction information included in a second ground truth corresponding to the second training image, to thereby train the head FC layer 1400 and the head convolutional layer 1300.

Herein, the learning device 1000 may use cross entropy as a loss function for generating the head direction loss, but the present disclosure is not limited thereto, and the head direction loss can be generated by using various loss functions.

Meanwhile, in the above, the learning device 1000 has trained at least some parameters of the head convolution layer 1300 and the head FC layer 1400 by using the head direction loss as it is, it is not limited thereto. For example, the learning device 1000 may also train at least some parameters of the head convolution layer 1300 and the head FC layer 1400 by applying a loss weight to the head direction loss.

As an example, in case the head direction loss is less than a preset threshold, “0” is applied as the loss weight, and in case the head direction loss is equal to or greater than the preset threshold, a preset real number greater than “0” is applied as the loss weight.

For another example, in case the first predicted head direction information corresponds to False which is actually True (FN: False Negative), “0” is applied as the loss weight, and in case the first predicted head direction information corresponds to True which is actually False (FP: False Positive), the preset real number greater than “0” is applied as the loss weight.

Next, during or after training the gaze detection model including the body convolutional layer 1100, the head convolutional layer 1300, and the head FC layer 1400, the learning device 1000 may evaluate the performance of the gaze detection model.

As an example, the learning device 1000 may input at least one evaluation image into the body convolutional layer 1100, to thereby instruct the body convolutional layer 1100 to perform the convolutional operation on the evaluation image at least once and thus generate at least one third body feature map by extracting body features of a third person included in the evaluation image, and input the evaluation image into the head convolutional layer 1300, to thereby instruct the head convolutional layer 1300 to perform the convolutional operation on the evaluation image at least once and thus generate at least one second head feature map by extracting head features of the third person. Further, the learning device 1000 may concatenate the third body feature map and the second head feature map to generate a second integrated feature map, and input the second integrated feature map into the head FC layer 1400, to thereby instruct the head FC layer 1400 to perform the FC operation on the second integrated feature map at least once and thus output at least one second predicted head direction information by predicting a direction in which a front of a head of the third person is directed. Further, the learning device 1000 may evaluate the gaze detection model including the body convolutional layer 1100, the head convolutional layer 1300, and the head FC layer 1400 by referring to the second predicted head direction information and a third ground truth corresponding to the evaluation image.

Herein, the learning device 1000 may calculate a degree of accuracy by using the second predicted head direction information and the third ground truth with a following mathematical formula, to thereby evaluate the gaze detection model using the calculated the degree of accuracy.

$$\frac{( \# of predicted soft corrects \times \frac{1}{2} + \# of predicted corrects )}{N}$$

In the above mathematical formula, the N is the total number of the second predicted head direction information used for evaluation, the # of predicted soft corrects is a cardinal number of a part of the second predicted head direction information that did not accurately predict a labeled correct answer, and the # of predicted corrects is a cardinal number of a part of the second predicted head direction information that accurately predicted the labeled correct answer.

As an example, assuming that each of the second predicted head direction information used for evaluation includes a True Positive (TP) that predicts True which is actually True, i.e., correct answer, a False Positive (FP) that predicts True which is actually False, i.e., incorrect answer, a False Negative (FN) that predicts False which is actually True, i.e., incorrect answer, and a True Negative (TN) that predicts False which is actually False, i.e., correct answer, the N may be TP+FP+FN+TN, the # of predicted corrects may be TP+TN, and the # of predicted soft corrects may be FN.

Meanwhile, although a process of training the body convolutional layer first, and then training the head convolutional layer and the head FC layer is described above, a process of training the body convolutional layer, the head convolutional layer and the head FC layer can be described as below. In the description below, detailed explanation on parts that can be easily understood from the above referring to FIG. 2 and FIG. 3 will be omitted.

In response to acquiring at least one training image, the learning device may (i) input the training image into the body convolutional layer, to thereby instruct the body convolutional layer to perform the convolutional operation on the training image at least once and thus generate at least one body feature map by extracting body features of the person included in the training image, and (ii) input the training image into the head convolutional layer, to thereby instruct the head convolutional layer to perform the convolutional operation on the training image at least once and thus generate at least one head feature map by extracting head features of the person included in the training image.

Also, the learning device may input the body feature map into the body FC layer, to thereby instruct the body FC layer to perform an FC operation on the body feature map at least once and thus output at least one predicted body direction information by predicting the direction in which the front of the body of the person faces.

In addition, the learning device may input an integrated feature map, which is generated by concatenating the body feature map and the head feature map, into the head FC layer, to thereby instruct the head FC layer to perform an FC operation on the integrated feature map at least once and thus output at least one predicted head direction information by predicting the direction in which the front of the head of the person is directed.

Also, the learning device may generate at least one body direction loss by referring to the predicted body direction information and the labeled body direction information included in the ground truth corresponding to the training image, and generate at least one head direction loss by referring to the predicted head direction information and the labeled head direction information included in the ground truth.

Next, the learning device may train the body FC layer and the body convolutional layer by referring to the body direction loss and train the head FC layer and the head convolutional layer by referring to the head direction loss.

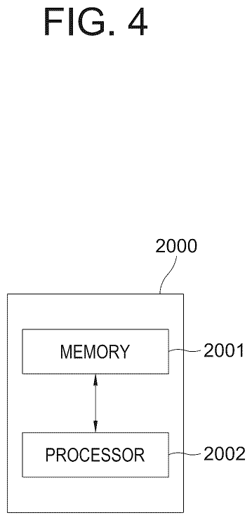

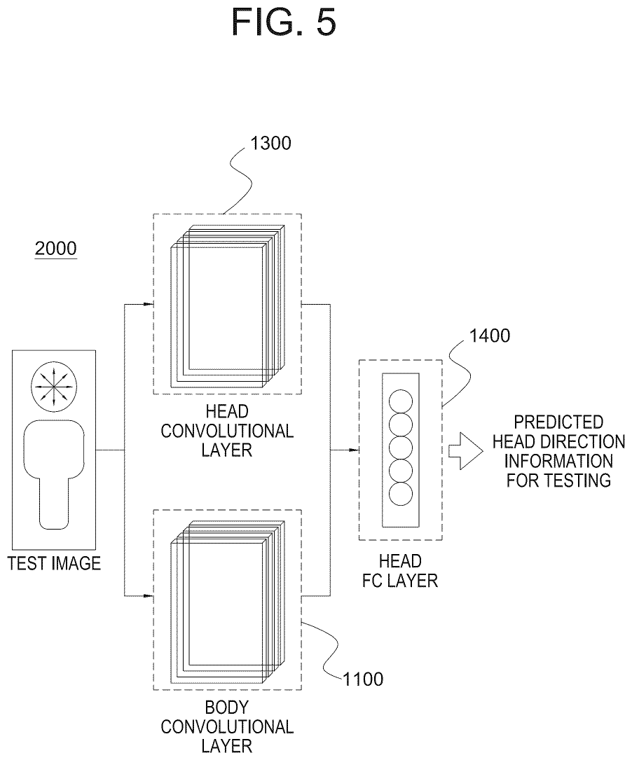

Likewise, on condition that the learning device 1000 have trained at least some parameters of the body convolutional layer 1100, the head convolutional layer 1300 and the head FC layer 1400, an operation of a test device in response to acquiring a test image, for example, an image of a pedestrian will be described below, with reference to FIG. 4 and FIG. 5.

First, a test device 2000 for testing the gaze detection model that detects the gaze will be described with reference to FIG. 4.

The test device 2000 may include at least one memory 2001 that stores instructions for testing the gaze detection model and at least one processor 2002 configured to perform an operation for testing the gaze detection model by executing the instructions stored in the memory 2001.

Specifically, the test device 2000 may achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network attached storage (NAS) device and a storage area network (SAN) as the computing device and any instructions that allow the computing device to function in a specific way as the computer software.

The processor of the computing device may include hardware configuration of MPU (Micro Processing Unit) or CPU (Central Processing Unit), cache memory, data bus, etc. Additionally, the computing device may further include OS and software configuration of applications that achieve specific purposes.

Such description of the computing device does not exclude an integrated device including any combination of a processor, a memory, a medium, or any other computing components for implementing the present disclosure.

Herein, the test device 2000 may be the same device as the learning device 1000 illustrated in FIG. 1, or may be a different device.

A process of testing the gaze detection model by the test device 2000 will be described below with reference to FIG. 5.

For reference, redundant descriptions identical or similar to those described for the learning device 1000 will be omitted.

First, on condition that at least some parameters of the body convolutional layer 1100, the head convolutional layer 1300 and the head FC layer 1400 have been trained by the learning device 1000, the test device 2000 may acquire the test image.

Also, the test device 2000 may input the test image into each of the head convolutional layer 1300 and the body convolutional layer 1100, to thereby instruct each of the head convolutional layer 1300 and the body convolutional layer 1100 to perform the convolutional operation on the test image at least once respectively and thus generate at least one head feature map for testing and at least one body feature map for testing respectively.

Also, the test device 2000 may concatenate the head feature map for testing and the body feature map for testing to generate an integrated feature map for testing, and input the integrated feature map for testing into the head fully connected (FC) layer 1400, to thereby instruct the head FC layer 1400 to perform the FC operation on the integrated feature map for testing at least once and thus output at least one predicted head direction information for testing.

Meanwhile, the training image, the first training image and the second training image used in the process of training the gaze detection model, and the evaluation image used in the process of evaluating the gaze detection model described above, are acquired by labeling each of corresponding ground truths, and a method for labeling each of the ground truths in an image of a person(s) is described as follows.

First, at least one photographed or cropped image of a person(s) may be obtained to generate the training image.

Herein, an image of a person may be obtained by photographing one person, or images of persons may be obtained from each bounding box acquired by detecting each person in one image. Also, a direction in which a front of a body of the person faces and a direction in which a front of a head of the person is directed in the image(s) may be labeled.

However, the present disclosure is not limited thereto, and the direction in which the front of the body of the person(s) is directed and the direction in which the front of the head of the person(s) is directed in a video of the person(s) may be labeled.

As an example, each of the body direction and the gaze of the corresponding person in the image may be labeled with each of a specific body direction class and a specific gaze class, each of which corresponds to each one among preset body direction classes and preset gaze classes in a two-dimensional plane or a three-dimensional space. Herein, if the specific body direction class and the specific gaze class are the same, only one direction class may be labeled.

In the two-dimensional plane, for example, when the direction in which the front of the body or the head of the person is directed is facing the camera (e.g., facing south), a corresponding specific direction class, among eight preset body direction classes, i.e., S, SE, E, NE, N, NW, W, SW on the two-dimensional plane, which corresponds to the direction in which the front of the body or the head of the person is directed may be labeled in the image. As another example, the corresponding specific direction class, among direction classes that divide 360-degree centered on the body or the head of the person into unit angles, may be labeled in the image. That is, when the 360-degree is divided 10-degree units, 36 discrete direction classes can be set, and when divided into 1-degree units, 360 discrete classes can be set. Thus, the corresponding specific direction class among the set direction classes may be labeled in the image. Also, the image may be labeled by further considering a default direction class corresponding to a case in which the front of the head of the person is directed to himself or herself.

Meanwhile, positive samples that accurately label the direction in which the front of the body or the head of the person is directed is described above, however, negative samples that label a direction other than the direction in which the front of the body or the head of the person is directed may also be labeled in the image.

Also, in the three-dimensional space, for example, the corresponding specific direction class, among 26 preset head direction classes along radial directions in the three-dimensional space (i.e., eight direction classes for eight directions in the reference plane corresponding to the person's height, eight direction classes up to an upper direction, eight direction classes up to a lower direction, an upper direction class toward the upper direction, and a lower direction class toward the lower direction) may be labeled in the image. In contrast, the corresponding specific direction class, among direction classes that divide a three-dimensional spherical coordinate system into unit coordinates, may be labeled in the image. Also, the image may be labeled by further considering a default direction class corresponding to the case in which the front of the head of the person is directed to himself or herself.

Meanwhile, positive samples that accurately label the direction in which the front of the body or the head of the person is directed is described above, however, negative samples that label a direction other than the direction in which the front of the body or the head of the person is directed may also be labeled in the image.

For another example, each of the body direction and the gaze of the corresponding person in the image may be labeled with each of a specific body direction vector and a specific gaze vector in the two-dimensional plane or the three-dimensional space.

In the two-dimensional plane, for example, a specific direction vector corresponding to one direction among continuous 360-degree directions centered on the body or the head of the person may be labeled in the image. Also, the image may be labeled by further considering a default direction vector corresponding to the case in which the front of the head of the person is directed to himself or herself.

Meanwhile, positive samples that accurately label the direction in which the front of the body or the head of the person is directed is described above, however, negative samples that label a direction other than the direction in which the front of the body or the head of the person is directed may also be labeled in the image.

Also, in the three-dimensional space, for example, the specific direction vector for a specific coordinate may be labeled in the image, wherein the specific coordinate corresponds to the direction in which the front of the body or the head of the person is directed among continuous coordinates in the three-dimensional spherical coordinate system corresponding to the three-dimensional space. Also, the image may be labeled by further considering the default direction vector corresponding to the case in which the front of the head of the person is directed to himself or herself.

Meanwhile, positive samples that accurately label the direction in which the front of the body or the head of the person is directed is described above, however, negative samples that label a direction other than the direction in which the front of the body or the head of the person is directed may also be labeled in the image.

Also, in the above, the image is directly labeled through its corresponding ground truth(s), however, if there is continuous direction information for the direction in which the front of the body or the head of the person is directed, the image may be labeled by using the continuous direction information.

As an example, a photographed image of a person wearing a gyroscope sensor may be labeled by (i) labeling with each of a specific body direction class and a specific gaze class, each of which corresponds to each of direction information and sensed gaze information among preset body direction classes and preset gaze classes in the two-dimensional plane or the three-dimensional space, or (ii) labeling each of the sensed body direction information and the sensed gaze information in the two-dimensional plane or the three-dimensional space as each of a body direction vector and a gaze vector of the corresponding person, through using the sensed body direction information and the sensed gaze information of the corresponding person acquired by using sensing information of the gyroscope sensor at a time of shooting the image.

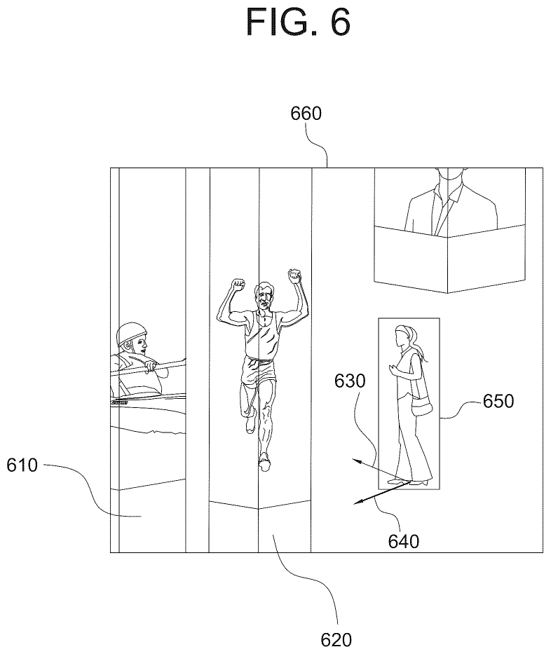

A method for labeling the ground truth using the gyroscope sensor will be specifically described below with reference to FIG. 6. A process of labeling the head direction information will be described, but a process of labeling the body direction information is similar, so a detailed description thereof will be omitted.

FIG. 6 is a drawing schematically illustrating a training image of a pedestrian facing at a second advertisement among a first advertisement posted on a first pillar 610 and the second advertisement posted on a second pillar 620, wherein both pillars are on a left side of the pedestrian.

Herein, (i) a direction 630 in which a body of the pedestrian is actually directed, i.e., GT body direction information, may be a vector corresponding to the (x1, y1, z1) components, and (ii) a direction 640 in which a face of the pedestrian is actually directed, i.e., GT head direction information, may be a vector corresponding to the (x2, y2, z2) components.

For reference, as illustrated in FIG. 6, z1 corresponding to the GT body direction information in a situation where the pedestrian walks on a plain may have a value of 0, for example, (x1, y1, z1) may correspond to (−1, 1, 0), or may have a value which is very small compared to x1 and/or y1, for example, (x1, y1, z1) may correspond to (−1, 1, 0.01). On the other hand, although it is not illustrated in FIG. 6, z1 corresponding to the GT body direction information in a situation where the pedestrian walks on a slope, for example, stairs, may have a non-zero value, for example, (x1, y1, z1) may correspond to (1, 2, 1).

Meanwhile, as illustrated in FIG. 6, the pedestrian may not only turn his or her head left and right, but also turn his or her head up and down, so z2 corresponding to the GT head direction information may have various values, for example, (x2, y2, z2) may correspond to (−1, −1, 1), regardless of which section the pedestrian walks.

For reference, as described above, the ground truth may correspond to information which is acquired by the gyroscope sensor mounted on the head of the pedestrian.

However, as illustrated in FIG. 6, when the first pillar 610 and the second pillar 620 are located at a close distance, or when the first pillar 610 and the second pillar 620 are located within a predetermined close viewing angle or a predetermined close viewing frustum of the pedestrian, it may be difficult to accurately label as to whether the pedestrian is looking at the first advertisement posted on the first pillar 610 or the second advertisement posted on the second pillar 620, only depending on the information acquired by the gyroscope sensor.

Thus, for more accurate labeling, (i) pedestrian assistance information (e.g., search information that a content corresponding to the second advertisement was searched by using a pedestrian terminal within 60 seconds from the time when the pedestrian was photographed, or history information of visiting a store of items related to the second advertisement or purchasing the items related to the second advertisement) which is acquired within a predetermined time interval from a time when the pedestrian was photographed, and (ii) information acquired from the gyroscope sensor may be used together.

Meanwhile, unlike training the gaze detection model by using the training image labeled with the ground truth as described above with reference to FIG. 2 and FIG. 3, it is also possible to train the gaze detection model in real time by using sensing information acquired through sensing the gyroscope sensor as the ground truth without generating the training image.

As an example, the learning device may obtain a video of the pedestrian walking who wears the gyroscope sensor. Herein, it may be assumed that the body direction information of the pedestrian which is acquired from the gyroscope sensor is (−1, 1, 0) and the head direction information of the pedestrian which is acquired from the gyroscope sensor is (−1, −1, 1).

Also, the learning device may input a cropped image acquired by cropping a region in which the pedestrian is included into the gaze detection model which has been trained as described above, and thus output the predicted head direction information, e.g., (−1.1, −1, 0.8), acquired by predicting the direction in which the front of the head of the pedestrian is directed.

Also, the learning device may generate the head direction loss by referring to the predicted head direction information, e.g., (−1.1, −1, 0.8) and actual head direction information, e.g., (−1, −1, 1), which is acquired by using sensing information of the gyroscope sensor, and perform backpropagation with the head direction loss to thereby train the gaze detection model.

Besides, the embodiments of the present disclosure as explained above can be implemented in a form of executable program command through a variety of computer means recordable to computer readable media. The computer readable media may store solely or in combination, program commands, data files, and data structures. The program commands recorded in the media may be components specially designed for the present disclosure or may be usable for a skilled person in a field of computer software. The computer readable media include, but are not limited to, magnetic media such as hard drives, floppy diskettes, magnetic tapes, memory cards, solid-state drives, USB flash drives, optical media such as CD-ROM and DVD, magneto-optical media such as floptical diskettes and hardware devices such as a read-only memory (ROM), a random access memory (RAM), and a flash memory specially designed to store and carry out program commands. Program commands may include not only a machine language code made by a compiler but also a high level code that can be used by an interpreter etc., which is executed by a computer. The aforementioned hardware device may work as more than a software module to perform the action of the present disclosure and they may do the same in the opposite case.

As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

1. A method of training a gaze detection model that detects a gaze of a person based on deep learning, comprising steps of:
(a) in response to acquiring at least one first training image, a learning device (i) inputting the first training image into a body convolutional layer, to thereby instruct the body convolutional layer to perform a convolutional operation on the first training image at least once and thus generate at least one first body feature map which is acquired by extracting body features of a first person included in the first training image, (ii) inputting the first body feature map into a body fully connected (FC) layer, to thereby instruct the body FC layer to perform an FC operation on the first body feature map at least once and thus output at least one predicted body direction information which is acquired by predicting a direction in which a front of a body of the first person faces, and (iii) generating at least one body direction loss by referring to the predicted body direction information and a labeled body direction information included in a first ground truth corresponding to the first training image, to thereby train the body FC layer and the body convolutional layer; and
(b) in response to acquiring at least one second training image, the learning device (i) inputting the second training image into the body convolutional layer, to thereby instruct the body convolutional layer to perform the convolutional operation on the second training image at least once and thus generate at least one second body feature map which is acquired by extracting body features of a second person included in the second training image, inputting the second training image into a head convolutional layer, to thereby instruct the head convolutional layer to perform the convolutional operation on the second training image at least once and thus generate at least one first head feature map which is acquired by extracting head features of the second person, and concatenating the second body feature map and the first head feature map to generate a first integrated feature map, (ii) inputting the first integrated feature map into a head FC layer, to thereby instruct the head FC layer to perform an FC operation on the first integrated feature map at least once and thus output at least one first predicted head direction information which is acquired by predicting a direction in which a front of a head of the second person is directed, and (iii) generating at least one head direction loss by referring to the first predicted head direction information and a labeled head direction information included in a second ground truth corresponding to the second training image, to thereby train the head FC layer and the head convolutional layer.

2. The method of claim 1, wherein, at the step of (b), the learning device further adds a loss weight to the head direction loss to thereby train the head FC layer and the head convolutional layer, wherein, in case the head direction loss is less than a preset threshold, “0” is applied as the loss weight, and wherein, in case the head direction loss is equal to or greater than the preset threshold, a preset real number greater than “0” is applied as the loss weight.

3. The method of claim 1, wherein, at the step of (b), the learning device instructs the head FC layer to output, as the first predicted head direction information, either (i) classification information which is acquired by classifying which class among preset head direction classes corresponds to the direction in which the front of the head of the second person is directed, or (ii) regression information which is acquired by regressing which direction among continuous direction candidates corresponds to the direction in which the front of the head of the second person is directed.

4. The method of claim 2, wherein the first predicted head direction information is a prediction of the direction in which the front of the head of the second person is directed in either a two-dimensional plane corresponding to the second training image or a three-dimensional space corresponding to the second training image.

5. The method of claim 1, wherein the first training image or the second training image is generated, in a photographed or cropped image of a person, (i) by labeling each of a body direction and a gaze of the corresponding person with each of a specific body direction class and a specific gaze class, each of which corresponds to each one among preset body direction classes and preset gaze classes in a two-dimensional plane or a three-dimensional space, or (ii) by labeling each of the body direction and the gaze of the corresponding person with each of a body direction vector and a gaze vector in the two-dimensional plane or the three-dimensional space.

6. The method of claim 1, wherein the first training image or the second training image is generated, in a photographed image of a person wearing a gyroscope sensor, (i) by labeling with each of a specific body direction class and a specific gaze class, each of which corresponds to each of sensed body direction information and sensed gaze information among preset body direction classes and preset gaze classes in a two-dimensional plane or a three-dimensional space, or (ii) by labeling each of the sensed body direction information and the sensed gaze information in the two-dimensional plane or the three-dimensional space with each of a body direction vector and a gaze vector of corresponding person, through using the sensed body direction information and the sensed gaze information of the corresponding person which is acquired by using sensing information of the gyroscope sensor at a time of shooting.

7. The method of claim 1, further comprising a step of:
(c) the learning device (i) inputting at least one evaluation image into the body convolutional layer, to thereby instruct the body convolutional layer to perform the convolutional operation on the evaluation image at least once and thus generate at least one third body feature map which is acquired by extracting body features of a third person included in the evaluation image, inputting the evaluation image into the head convolutional layer, to thereby instruct the head convolutional layer to perform the convolutional operation on the evaluation image at least once and thus generate at least one second head feature map which is acquired by extracting head features of the third person included in the evaluation image, and concatenating the third body feature map and the second head feature map to generate a second integrated feature map, (ii) inputting the second integrated feature map into the head FC layer, to thereby instruct the head FC layer to perform the FC operation on the second integrated feature map at least once and thus output at least one second predicted head direction information which is acquired by predicting a direction in which a front of a head of the third person is directed, and (iii) evaluating the gaze detection model including the body convolutional layer, the head convolutional layer, and the head FC layer by referring to the second predicted head direction information and a third ground truth corresponding to the evaluation image.

8. The method of claim 7, wherein the learning device calculates a degree of accuracy using the second predicted head direction information and the third ground truth with a following mathematical formula, to thereby evaluate the gaze detection model using the calculated the degree of accuracy
$$\frac{( \# of predicted soft corrects \times \frac{1}{2} + \# of predicted corrects )}{N}$$
wherein the N is a total number of the second predicted head direction information used for evaluation, the # of predicted soft corrects is a cardinal number of a part of the second predicted head direction information that did not accurately predict a labeled correct answer, and the # of predicted corrects is a cardinal number of a part of the second predicted head direction information that accurately predicted the labeled correct answer.

9. A method of training a gaze detection model that detects a gaze of a person based on deep learning, comprising steps of:
(a) in response to acquiring at least one training image, a learning device (i) inputting the training image into a body convolutional layer, to thereby instruct the body convolutional layer to perform a convolutional operation on the training image at least once and thus generate at least one body feature map which is acquired by extracting body features of a person included in the training image, (ii) inputting the training image into a head convolutional layer, to thereby instruct the head convolutional layer to perform a convolutional operation on the training image at least once and thus generate at least one head feature map which is acquired by extracting head features of a person included in the training image;
(b) the learning device (i) inputting the body feature map into a body FC layer, to thereby instruct the body FC layer to perform an FC operation on the body feature map at least once and thus output at least one predicted body direction information which is acquired by predicting a direction in which a front of a body of the person faces, and (ii) inputting an integrated feature map, which is generated by concatenating the body feature map and the head feature map, into a head FC layer, to thereby instruct the head FC layer to perform an FC operation on the integrated feature map at least once and thus output at least one predicted head direction information which is acquired by predicting a direction in which a front of a head of the person is directed; and
(c) the learning device (i) generating at least one body direction loss by referring to the predicted body direction information and a labeled body direction information included in a ground truth corresponding to the training image, and generating at least one head direction loss by referring to the predicted head direction information and a labeled head direction information included in the ground truth, and (ii) training the body FC layer and the body convolutional layer by referring to the body direction loss and training the head FC layer and the head convolutional layer by referring to the head direction loss.

10. The method of claim 9, wherein the training image is generated, in a photographed or cropped image of a person, (i) by labeling each of a body direction and a gaze of the corresponding person with each of a specific body direction class and a specific gaze class, each of which corresponds to each one among preset body direction classes and preset gaze classes in a two-dimensional plane or a three-dimensional space, or (ii) by labeling each of the body direction and the gaze of the corresponding person with each of a body direction vector and a gaze vector in the two-dimensional plane or the three-dimensional space.

11. The method of claim 9, wherein the training image is generated, in a photographed image of a person wearing a gyroscope sensor, (i) by labeling with each of a specific body direction class and a specific gaze class, each of which corresponds to each of sensed body direction information and sensed gaze information among preset body direction classes and preset gaze classes in a two-dimensional plane or a three-dimensional space, or (ii) by labeling each of the sensed body direction information and the sensed gaze information in the two-dimensional plane or the three-dimensional space with each of a body direction vector and a gaze vector of corresponding person, through using the sensed body direction information and the sensed gaze information of the corresponding person which is acquired by using sensing information of the gyroscope sensor at a time of shooting.

12. A learning device for training a gaze detection model that detects a gaze of a person based on deep learning, comprising:
at least one memory that stores instructions for training a gaze detection model that detects a gaze of a person based on deep learning; and
at least one processor configured to perform operations for training the gaze detection model by executing the instructions stored in the memory, wherein the processor performs processes of:
(I) in response to acquiring at least one first training image, (i) inputting the first training image into a body convolutional layer, to thereby instruct the body convolutional layer to perform a convolutional operation on the first training image at least once and thus generate at least one first body feature map which is acquired by extracting body features of a first person included in the first training image, (ii) inputting the first body feature map into a body fully connected (FC) layer, to thereby instruct the body FC layer to perform an FC operation on the first body feature map at least once and thus output at least one predicted body direction information which is acquired by predicting a direction in which a front of a body of the first person faces, and (iii) generating at least one body direction loss by referring to the predicted body direction information and a labeled body direction information included in a first ground truth corresponding to the first training image, to thereby train the body FC layer and the body convolutional layer; and (II) in response to acquiring at least one second training image, (i) inputting the second training image into the body convolutional layer, to thereby instruct the body convolutional layer to perform the convolutional operation on the second training image at least once and thus generate at least one second body feature map which is acquired by extracting body features of a second person included in the second training image, inputting the second training image into a head convolutional layer, to thereby instruct the head convolutional layer to perform the convolutional operation on the second training image at least once and thus generate at least one first head feature map which is acquired by extracting head features of the second person, and concatenating the second body feature map and the first head feature map to generate a first integrated feature map, (ii) inputting the first integrated feature map into a head FC layer, to thereby instruct the head FC layer to perform an FC operation on the first integrated feature map at least once and thus output at least one first predicted head direction information which is acquired by predicting a direction in which a front of a head of the second person is directed, and (iii) generating at least one head direction loss by referring to the first predicted head direction information and a labeled head direction information included in a second ground truth corresponding to the second training image, to thereby train the head FC layer and the head convolutional layer.

13. The learning device of claim 12, wherein, at the process of (II), the processor further adds a loss weight to the head direction loss to thereby train the head FC layer and the head convolutional layer, wherein, in case the head direction loss is less than a preset threshold, “0” is applied as the loss weight, and wherein, in case the head direction loss is equal to or greater than the preset threshold, a preset real number greater than “0” is applied as the loss weight.

14. The learning device of claim 12, wherein, at the process of (II), the processor instructs the head FC layer to output, as the first predicted head direction information, either (i) classification information which is acquired by classifying which class among preset head direction classes corresponds to the direction in which the front of the head of the second person is directed, or (ii) regression information which is acquired by regressing which direction among continuous direction candidates corresponds to the direction in which the front of the head of the second person is directed.

15. The learning device of claim 13, wherein the first predicted head direction information is a prediction of the direction in which the front of the head of the second person is directed in either a two-dimensional plane corresponding to the second training image or a three-dimensional space corresponding to the second training image.

16. The learning device of claim 12, wherein the first training image or the second training image is generated, in a photographed or cropped image of a person, (i) by labeling each of a body direction and a gaze of the corresponding person with each of a specific body direction class and a specific gaze class, each of which corresponds to each one among preset body direction classes and preset gaze classes in a two-dimensional plane or a three-dimensional space, or (ii) by labeling each of the body direction and the gaze of the corresponding person with each of a body direction vector and a gaze vector in the two-dimensional plane or the three-dimensional space.

17. The learning device of claim 12, wherein the first training image or the second training image is generated, in a photographed image of a person wearing a gyroscope sensor, (i) by labeling with each of a specific body direction class and a specific gaze class, each of which corresponds to each of sensed body direction information and sensed gaze information among preset body direction classes and preset gaze classes in a two-dimensional plane or a three-dimensional space, or (ii) by labeling each of the sensed body direction information and the sensed gaze information in the two-dimensional plane or the three-dimensional space with each of a body direction vector and a gaze vector of corresponding person, through using the sensed body direction information and the sensed gaze information of the corresponding person which is acquired by using sensing information of the gyroscope sensor at a time of shooting.

18. The learning device of claim 12, wherein the processor further performs a process of: (III) (i) inputting at least one evaluation image into the body convolutional layer, to thereby instruct the body convolutional layer to perform the convolutional operation on the evaluation image at least once and thus generate at least one third body feature map which is acquired by extracting body features of a third person included in the evaluation image, inputting the evaluation image into the head convolutional layer, to thereby instruct the head convolutional layer to perform the convolutional operation on the evaluation image at least once and thus generate at least one second head feature map which is acquired by extracting head features of the third person included in the evaluation image, and concatenating the third body feature map and the second head feature map to generate a second integrated feature map, (ii) inputting the second integrated feature map into the head FC layer, to thereby instruct the head FC layer to perform the FC operation on the second integrated feature map at least once and thus output at least one second predicted head direction information which is acquired by predicting a direction in which a front of a head of the third person is directed, and (iii) evaluating the gaze detection model including the body convolutional layer, the head convolutional layer, and the head FC layer by referring to the second predicted head direction information and a third ground truth corresponding to the evaluation image.

19. The learning device of claim 18, wherein the processor calculates a degree of accuracy using the second predicted head direction information and the third ground truth with a following mathematical formula, to thereby evaluate the gaze detection model using the calculated the degree of accuracy
$$\frac{( \# of predicted soft corrects \times \frac{1}{2} + \# of predicted corrects )}{N}$$
wherein the N is a total number of the second predicted head direction information used for evaluation, the # of predicted soft corrects is a cardinal number of a part of the second predicted head direction information that did not accurately predict a labeled correct answer, and the # of predicted corrects is a cardinal number of a part of the second predicted head direction information that accurately predicted the labeled correct answer.

20. A learning device for training a gaze detection model that detects a gaze of a person based on deep learning, comprising:
at least one memory that stores instructions for training a gaze detection model that detects a gaze of a person based on deep learning; and
at least one processor configured to perform operations for training the gaze detection model by executing the instructions stored in the memory, wherein the processor performs processes of: (I) in response to acquiring at least one training image, (i) inputting the training image into a body convolutional layer, to thereby instruct the body convolutional layer to perform a convolutional operation on the training image at least once and thus generate at least one body feature map which is acquired by extracting body features of a person included in the training image, (ii) inputting the training image into a head convolutional layer, to thereby instruct the head convolutional layer to perform a convolutional operation on the training image at least once and thus generate at least one head feature map which is acquired by extracting head features of a person included in the training image; (II) (i) inputting the body feature map into a body FC layer, to thereby instruct the body FC layer to perform a n FC operation on the body feature map at least once and thus output at least one predicted body direction information which is acquired by predicting a direction in which a front of a body of the person faces, and (ii) inputting an integrated feature map, which is generated by concatenating the body feature map and the head feature map, into a head FC layer, to thereby instruct the head FC layer to perform an FC operation on the integrated feature map at least once and thus output at least one predicted head direction information which is acquired by predicting a direction in which a front of a head of the person is directed; and (III) (i) generating at least one body direction loss by referring to the predicted body direction information and a labeled body direction information included in a ground truth corresponding to the training image, and generating at least one head direction loss by referring to the predicted head direction information and a labeled head direction information included in the ground truth, and (ii) training the body FC layer and the body convolutional layer by referring to the body direction loss and training the head FC layer and the head convolutional layer by referring to the head direction loss.

21. The learning device of claim 20, wherein the training image is generated, in a photographed or cropped image of a person, (i) by labeling each of a body direction and a gaze of the corresponding person with each of a specific body direction class and a specific gaze class, each of which corresponds to each one among preset body direction classes and preset gaze classes in a two-dimensional plane or a three-dimensional space, or (ii) by labeling each of the body direction and the gaze of the corresponding person with each of a body direction vector and a gaze vector in the two-dimensional plane or the three-dimensional space.

22. The learning device of claim 20, wherein the training image is generated, in a photographed image of a person wearing a gyroscope sensor, (i) by labeling with each of a specific body direction class and a specific gaze class, each of which corresponds to each of sensed body direction information and sensed gaze information among preset body direction classes and preset gaze classes in a two-dimensional plane or a three-dimensional space, or (ii) by labeling each of the sensed body direction information and the sensed gaze information in the two-dimensional plane or the three-dimensional space with each of a body direction vector and a gaze vector of corresponding person, through using the sensed body direction information and the sensed gaze information of the corresponding person which is acquired by using sensing information of the gyroscope sensor at a time of shooting.
